(19) United States
(12) Patent Application Publication
(10) Pub. No.: US 2024/0405234 A1
(43) Pub. Date: Dec. 5, 2024

(54) FUEL CELL SYSTEM HAVING IMPROVED STARTING UNDER FREEZING CONDITIONS

(71) Applicant: Robert Bosch GmbH, Stuttgart (DE)

(72) Inventors: Helerson Kemmer, Vaihingen (DE); Matthias Rink, Herrenberg (DE)

(21) Appl. No.: 18/691,583

(22) PCT Filed: Sep. 26, 2022
(86) PCT No.: PCT/EP2022/076631

§ 371 Date: Mar. 13, 2024

(30) Foreign Application Priority Data
Sep. 29, 2021 (DE) 10 2021 210 890.3

(51) Int. Cl. H01M 8/04225; H01M 8/04029; H01M 8/04223; H01M 8/0432; H01M 8/04746; H01M 8/04858

(52) U.S. Cl. CPC H01M 8/04225; H01M 8/04029; H01M 8/04253; H01M 8/04268; H01M 8/04358; H01M 8/04768; H01M 8/0488; H01M 8/0491

(57) ABSTRACT

The invention relates to a fuel cell system, comprising: at least one fuel cell; a cooling device; at least one temperature sensor; and a control unit; wherein the cooling device comprises a coolant path for the flow of a coolant, a coolant pump, a heat releasing device, and a bypass, which can be operated by means of a bypass valve and which is parallel to the heat releasing device. A control unit is designed such that it senses the coolant outlet temperature or the coolant inlet temperature, identifies a first rising phase of the measured temperature during a start-up phase of the fuel cell system, monitors the measured temperature for a plateau after the first rising phase has been identified, identifies a second rising phase following the plateau, and, during the plateau, reduces a conveyed volumetric flow rate of the coolant in the coolant path and/or increases a current flow in the at least one fuel cell and/or reduces a cell voltage.

### BACKGROUND

The present invention relates to a fuel cell system and a method for operating a fuel cell system.

Vehicles are known in which electrical power is supplied by a fuel cell system comprising a fuel cell stack and is used to supply drive motors. Hydrogen is in this case catalytically combined with an oxidant, usually oxygen from the ambient air, and catalytically bound to water in order to generate electrical power. The ambient air is supplied to a cathode path of the fuel cell stack by means of an air conveying system or air compression system. Waste heat from the fuel cell system is dissipated by means of a cooling circuit and released into the environment via a main vehicle radiator. The cooling circuit can comprise a coolant pump for pumping a coolant. A bypass for circulating the main vehicle radiator can be provided in order to heat up the fuel cell stack as quickly as possible during the start-up phase at low temperatures, in particular at ambient temperatures below 0° C. A fast warm-up ensures that no water or ice accumulates, which would make it difficult or impossible to continue the start. However, the risk of icing is only overcome when the coolant has warmed up above 0° C., at least in the bypass. As a result, freezing conditions are not present when the coolant is pumped into the fuel cell stack.

When starting under freezing conditions according to the prior art, the coolant is heated either externally or by the electrochemical reaction in the fuel cell stack. In both cases, the start-up process is delayed as a result. It is also necessary to increase the fuel cells of the stack due to the constant cooling below 0° C. This is achieved by installing ice buffers in the fuel cells, heaters in the fuel cell system, and other measures.

### SUMMARY

The object of the invention to propose a fuel cell system in which starting under freezing conditions is improved and, at the same time, a coolant volumetric flow is sufficient during the starting under freezing conditions to avoid overheated areas within the fuel cell stack, to prevent an excessive temperature difference between a coolant inlet and a coolant outlet and, at the same time, to prevent an area around the coolant inlet from icing due to the temperature drop caused by the cold incoming coolant.

This object is achieved by a fuel cell system according to the disclosure. Advantageous embodiments and further developments can be gathered from the dependent claims and the description hereinafter.

Proposed is fuel cell system comprising at least one fuel cell, a cooling device, at least one temperature sensor, and a control unit, whereby the cooling device comprises a coolant path for the flow of a coolant, a coolant pump and a heat releasing device, whereby the control unit is coupled to the coolant pump and the at least one temperature sensor, whereby the coolant path is connected to a coolant inlet and a coolant outlet of the at least one fuel cell, and whereby the at least one temperature sensor is designed to sense at least a coolant outlet temperature of the coolant at the coolant outlet or a coolant inlet temperature of the coolant at the coolant inlet. It is provided that the control unit is designed to sense the coolant outlet temperature or coolant inlet temperature as a measured temperature, to identify a first rising phase of the measured temperature during a start-up phase of the fuel cell system, during which the measured temperature rises continuously at a first rate of rise, to monitor the measured temperature for a plateau of the measured temperature after identification of the first rising phase, during which a rate of rise of the measured temperature corresponds at most to a predetermined proportion of a maximum first rate of rise, to identify a second rising phase following the plateau, during which the measured temperature rises continuously at a second rise rate which exceeds the rise rate of the plateau and, during the plateau, to reduce a conveyed volumetric flow rate of the coolant through the heat releasing device, and/or to increase a current flow in the at least one fuel cell, and/or to reduce a cell voltage.

The fuel cell system preferably comprises multiple fuel cells that are combined to form a fuel cell stack. When used in motor vehicles or commercial vehicles, it is particularly advantageous to use polymer electrolyte membrane (PEM) fuel cells in which the anode is separated from the cathode by a membrane. Alternatively, other forms of fuel cells could of course also be implemented, which can comprise, among other things, solid oxide and direct methanol fuel cells.

The fuel cells can be coupled on the cathode side to an air supply unit, which could comprise one or more compressors that feed pressurized air into a cathode path upstream of the fuel cell system. The compressor(s) could be driven by an electric motor supplied with a voltage provided by the fuel cell system itself and/or an external voltage source, e.g. a backup battery. In addition, a turbine could also be provided, which is arranged downstream of the fuel cells in the cathode path and supports the compressor(s). On the anode side, hydrogen is supplied from a hydrogen source.

The fuel cells are designed such that they comprise a coolant inlet and a coolant outlet. If the fuel cells are combined to form a fuel cell stack, the latter can comprise a coolant path having a coolant inlet and a coolant outlet. Coolant that enters the coolant inlet comes into thermal contact with the fuel cells, where it absorbs at least some of the heat generated by the fuel cell process and leaves the fuel cells through the coolant outlet. If the measured temperature is higher or significantly higher than 0° C., then it can be conveyed through the heat releasing device which is, e.g., designed in the form of a vehicle radiator. The absorbed heat is thus dissipated into the environment.

The at least one temperature sensor is designed to sense the temperature of the coolant at the coolant outlet or at the coolant inlet. This temperature can be an indication of whether there is a risk of icing inside the fuel cells. Surprisingly, it has proven that sensing and evaluating the temperature of the coolant at the coolant outlet in the form of recognizing a plateau is advantageous for improving starting under freezing conditions.

When performing starting under freezing conditions, the temperature of the coolant does not initially increase due to the low flow rate caused by the high viscosity of the coolant. However, as soon as the temperature increases, the first rising phase is reached. In this case, the temperature rises continuously and has a maximum first rate of increase, which is reached approximately in the middle of the first rising phase.

After the first rising phase has been reached, the temperature progression is searched for a plateau. If the temperature of the coolant remains constant or within a certain steady-state range for a defined time interval, the start of the plateau is recognized. The rate of increase of the measured temperature is significantly below the maximum first rate of increase. The rate of increase could correspond to a maximum of 25%, further by way of example 10%, but preferably significantly less than the maximum first rate of increase.

As soon as the coolant outlet temperature or coolant inlet temperature rises again, the end of the plateau is recognized. During this plateau, the heating gradient of the fuel cells decreases sharply due to the inflow of cold coolant. Negative temperature gradients can therefore not be ruled out. By recognizing the plateau, the heating gradient can be improved by adjusting the volumetric flow of coolant through the heat releasing device. This significantly speeds up the defrosting process.

The volumetric flow could, e.g., be influenced by actuating the coolant pump. Alternatively or additionally, the heat input can be increased by increasing the current or reducing the cell voltage. The efficiency of at least one fuel cell can thus be reduced for the start-up phase and the heating process accelerated.

The sensing of the temperature could be extended to the sensing of similar or other variables of elements of the fuel cell system. In principle, it is also conceivable to sense an anode and/or cathode temperature and evaluate it with regard to the identification of the rising phases. The anode or cathode temperature could already be sensed in a fuel cell system, so that the information about this can be used in the control unit in accordance with the invention. Furthermore, sensing the coolant volumetric flow could also serve as a possible parameter for recognizing the plateau. Given a constant pump capacity, the coolant volumetric flow can be influenced by a changing viscosity, so that it would also be possible to recognize the plateau.

The control unit could also be designed to actuate the coolant pump during the plateau in order to reduce the conveyed volumetric flow rate. The control unit thus directly influences the conveyed volumetric flow rate and can improve the heating gradient within the fuel cell system immediately after recognizing the start of the plateau. The actuation can be performed on the basis of a control strategy in which further parameters are taken into account, comprising an ambient temperature, a service life, the age of the at least one fuel cell or other parameters.

The control unit could also be designed to actuate a bypass valve of a bypass arranged parallel to the heat releasing device during the plateau in order to guide coolant in the coolant path at least partially through the bypass. The part of the coolant routed through the bypass is therefore not routed through the heat releasing device and consequently does not release any heat to the outside. The heating gradient is therefore increased immediately during the starting under freezing conditions by opening the bypass.

The control unit could be designed to recognize the start of the plateau by ensuring that the measured temperature rises by no more than a predetermined first temperature difference over a predetermined time interval. The plateau is characterized by chronologically flat measured temperature progression. The latter only increases by a small amount over the predetermined time interval, which is referred to herein as the first temperature difference. The smaller the first temperature difference, the flatter the plateau. The beginning and end of the plateau can be continuously associated with the first and second rising phases by a transition area. By adapting the recognition criteria, a measurement frequency, and a control strategy, the transition areas could previously be recognized.

The control unit could be designed to recognize the end of the plateau by the measured temperature having risen by at least a predetermined second temperature difference over a predetermined time interval. The second temperature difference could essentially correspond to the first temperature difference. However, it is quite conceivable that the second temperature difference can deviate from the first temperature difference depending on the ambient conditions. It is therefore advantageous to achieve the recognition of the end of the plateau by means of an individually adapted second temperature difference.

The first temperature difference and/or the second temperature difference could be in a range from 1 to 3 K. It may be advantageous to define the relevant temperature difference as roughly 2 K if, e.g., a time interval is 0.1 s. The individual adjustment of these variables, i.e. the temperature differences and the time interval, takes into account the design of the fuel cell system and could be determined in particular by practical investigations in the form of test series.

The control unit could be designed to adapt control of the cooling device for a subsequent starting under freezing conditions based on an initial speed of the coolant pump, an ambient temperature of the fuel cell system, a heat input by the fuel cell system, and/or a presence or a chronological duration of the plateau. A previously performed start under freezing conditions using accompanying measurements of the coolant outlet temperature or the coolant inlet temperature can therefore be used to improve the control of the conveyed volumetric flow rate and/or the current and voltage for subsequent starting under freezing conditions. The fuel cell system can therefore be self-learning in order to improve a control strategy for the starting under freezing conditions. Aging effects and changing ambient conditions can better be taken into account thereby.

The invention further relates to a method for operating a fuel cell system, comprising the steps of supplying reaction gases to at least one fuel cell and conveying coolant through a coolant path of a cooling device extending through the at least one fuel cell by means of a coolant pump. According to the invention, the method comprises sensing a coolant outlet temperature at a coolant outlet or a coolant inlet temperature of the coolant at the coolant inlet of the at least one fuel cell by means of at least one temperature sensor by a control unit as a measured temperature, identifying a first rising phase of the measured temperature, during which the measured temperature rises continuously at a first rate of rise, during a start-up phase of the fuel cell system by means of the control unit, monitoring the measured temperature for a plateau of the measured temperature after identification of the first rising phase, during which a rate of rise of the measured temperature corresponds at most to a predetermined proportion of a maximum first rate of rise, identifying a second rising phase following the plateau, during which the measured temperature rises continuously at a second rate of rise which exceeds the rate of rise of the plateau, and during the plateau reducing a conveyed volumetric flow rate of the coolant through the heat releasing device and/or increasing a current flow in the at least one fuel cell and/or reducing a cell voltage.

The method can further comprise the step of the control unit actuating a bypass valve of a bypass arranged parallel to the heat releasing device during the plateau in order to guide coolant in the coolant path at least partially through the bypass.

The method can further comprise the step of the control unit adapting control of the cooling device for subsequent starting under freezing conditions from an initial speed of the coolant pump, an ambient temperature of the fuel cell system, a heat input by the fuel cell system, and/or a presence or a chronological duration of the plateau.

### BRIEF DESCRIPTION OF THE DRAWINGS

Further measures improving the invention are described in greater detail hereinafter, together with the description of the preferred exemplary embodiments of the invention, with reference to the drawings.

Shown are:

FIG. 1 a schematic view of the fuel cell system;

FIG. 2 a diagram including multiple variables during the starting under freezing conditions;

FIG. 3 a schematic, block-based representation of the method.

### DETAILED DESCRIPTION

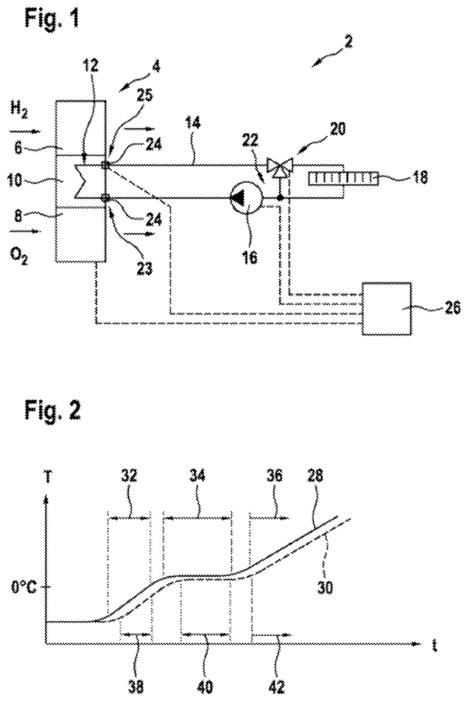

FIG. 1 shows, very schematically, a part of a fuel cell system 2 comprising a fuel cell 4 having an anode 6, a cathode 8, and a heat transfer device 10 thermally coupled to the anode 6 and the cathode 8 with a heat absorption path 12 for a coolant. The heat transfer device 10 need not be located between the anode 6 and the cathode 8 of a single fuel cell 4, but can also be realized in a bipolar plate between two adjacent fuel cells. The illustration is therefore only schematic and is intended to indicate that a heat transfer device 10 is provided, which can conduct heat from the fuel cell 4 to the outside.

The anode 6 is supplied with hydrogen, whereas the cathode 8 is supplied with oxygen, e.g. in the form of air, in order to perform the fuel cell process.

The heat absorption path 12 is coupled to a coolant path 14, in which coolant is conveyed via a coolant pump 16. A heat releasing device 18 is coupled to the coolant path 14 and can dissipate heat from the coolant to the outside. For example, the heat releasing device 18 can be realized as a radiator or the main radiator of a vehicle. A bypass valve 20 is provided in the coolant path 14 and can selectively direct coolant through a bypass 22, which is arranged parallel to the heat releasing device 18. Coolant can therefore be circulated in the coolant path 14 without heat releasing.

A temperature sensor 24 is arranged at a coolant inlet 23 and a further temperature sensor 24 is arranged at a coolant outlet 25 of the fuel cell 4 and coupled to a control unit 26. It may be advantageous to use only one of these two temperature sensors 24.

The control unit 26 is in turn connected to the coolant pump 16 and the bypass valve 20, as well as to the fuel cell 4. The control unit 26 is designed to sense a coolant outlet temperature, to identify a first rising phase of the coolant outlet temperature during a start-up phase of the fuel cell system 2, during which the coolant outlet temperature rises continuously at a first rate of rise, to monitor the coolant outlet temperature for a plateau of the coolant outlet temperature after identification of the first rising phase, at which a rate of rise of the coolant outlet temperature corresponds at most to a predetermined proportion of a maximum first rate of rise, to identify a second rising phase following the plateau, at which the coolant outlet temperature rises continuously at a second rate of rise which exceeds the rate of rise of the plateau, and during the plateau to reduce a conveyed volumetric flow rate of the coolant through the heat releasing device 18 and/or to increase a current flow in the at least one fuel cell 4 and/or to reduce a cell voltage. The conveyed volumetric flow rate can be reduced by actuating the pump 16 accordingly, and/or by actuating the bypass valve 20. By actuating the fuel cell 4 accordingly, e.g. by influencing a resistor, the electrical properties of the fuel cell 4 could be influenced to temporarily increase the power loss in order to improve heating during the starting under freezing conditions.

FIG. 2 shows, by way of example, the chronological progression of a coolant outlet temperature 28 and a coolant inlet temperature 30 during starting under freezing conditions from a temperature below 0° C. In this case, there is a first rising phase 32 of the coolant outlet temperature 28, during which the latter rises continuously. This is followed by a plateau 34, during which the coolant outlet temperature 28 remains virtually unchanged. This can relate to a temperature just above 0° C. This is followed by a second rising phase 36. The same can be observed for the coolant inlet temperature 30, which initially forms a first rising phase 38, a plateau 40, and a second rising phase 42.

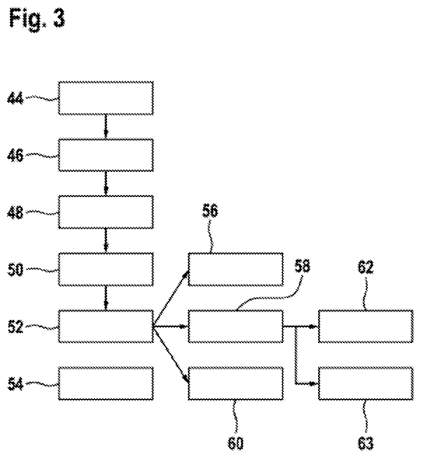

FIG. 3 shows a method for operating the fuel cell system 2, comprising the steps of supplying 44 reaction gases to the fuel cell 4, conveying 46 coolant through a coolant path 14, sensing 48 the coolant outlet temperature 28 or the coolant inlet temperature 30 by means of the temperature sensor 24 as the measured temperature, identifying 50 the first rising phase 32 or 38 of the measured temperature, monitoring 52 the measured temperature towards the plateau 34 or 40 and further identifying 54 the second rising phase 36 or 42. During the plateau, a conveyed volumetric flow rate of the coolant through the heat releasing device 18 can be reduced 56 and/or a current flow in the fuel cell 4 can be increased 58 and/or a cell voltage can be reduced 60. In order to reduce 56 the conveyed volumetric flow rate through the heat dissipation device 18, the control unit can actuate 62 the bypass valve 20 to direct coolant in the coolant path 14 at least partially through the bypass 22. Alternatively or additionally, the coolant pump 16 can be actuated 63.

Finally, the control unit 26 can adapt control of the cooling device for subsequent starting under freezing conditions 64 from an initial rotational speed of the coolant pump 16, an ambient temperature of the fuel cell system 2, a heat input by the fuel cell system 2 and/or a presence or a chronological duration of the plateau 34 or 40.

1. A fuel cell system (2) comprising:
at least one fuel cell (4),
a cooling device,
at least one temperature sensor (24), and
a control unit (26),
wherein the cooling device comprises a coolant path (14) for the flow of a coolant, a coolant pump (16), and a heat-releasing device (18),
wherein the control unit (26) is coupled to the coolant pump (16) and the at least one temperature sensor (24),
wherein the coolant path (14) is connected to a coolant inlet (23) and a coolant outlet (25) of the at least one fuel cell (4), and
wherein the at least one temperature sensor (24) is configured such that it senses at least one coolant outlet temperature (28) of the coolant at the coolant outlet (25) or a coolant inlet temperature (30) of the coolant at the coolant inlet (23),
wherein the control unit (26) is configured such that it: senses the coolant outlet temperature (28) or the coolant inlet temperature (30) as a measured temperature,
identifies a first rising phase (32, 38) of the measured temperature during a starting phase of the fuel cell system (2), during which the measured temperature rises continuously at a first rate of rise,
monitors the measured temperature for a plateau (34, 40) after the first rising phase (32, 38) has been identified, during which a rate of rise of the measured temperature corresponds to at most a predetermined portion of a maximum first rate of rise,
identifies a second rising phase (36, 42) following the plateau (34, 40), during which the measured temperature rises continuously at a second rate of rise which exceeds the rate of rise of the plateau (34, 40) and,
during the plateau (34, 40) reduces a conveyed volumetric flow rate of the coolant through the heat releasing device (18), and/or increase a current flow in the at least one fuel cell (4), and/or reduce a cell voltage.

2. The fuel cell system (2) according to claim 1,
wherein the control unit (26) is configured to actuate the coolant pump (16) during the plateau (34, 40) in order to reduce the conveyed volumetric flow rate.

3. The fuel cell system (2) according to claim 1,
wherein the control unit (26) is configured to actuate a bypass valve (20) of a bypass (22) arranged parallel to the heat releasing device (18) during the plateau (34, 40) in order to guide coolant in the coolant path (14) at least partially through the bypass (22).

4. The fuel cell system (2) according to claim 1,
wherein the control unit (26) is configured to recognize the start of the plateau (34, 40) by the measured temperature having risen by at most a predetermined first temperature difference over a predetermined time interval.

5. The fuel cell system (2) according to claim 1,
wherein the control unit (26) is configured to recognize the end of the plateau (34, 40) by the measured temperature having risen by at least a predetermined second temperature difference over a predetermined time interval.

6. The fuel cell system (2) according to claim 4,
wherein the first temperature difference and/or the second temperature difference lies within a range from 1 to 3 K.

7. The fuel cell system (2) according to claim 1,
wherein the control unit (26) is configured to adapt control of the cooling device for subsequent starting under freezing conditions from an initial rotational speed of the coolant pump (16), an ambient temperature of the fuel cell system (2), a heat input by the fuel cell system (2), and/or a presence or a chronological duration of the plateau (34, 40).

8. A method for operating a fuel cell system (2), comprising the following steps:
supplying (44) the reaction gases to at least one fuel cell (4),
conveying (46) coolant through a coolant path (14) of a cooling device extending through the at least one fuel cell (4) by means of a coolant pump (16),
wherein
sensing (48) a coolant outlet temperature (28) at a coolant outlet (25) or a coolant inlet temperature (30) at a coolant inlet (23) of the at least one fuel cell (4) using at least one temperature sensor (24) by means of a control unit (26) as a measured temperature,
identifying (50) a first rising phase (32, 38) of the measured temperature, during which the measured temperature rises continuously at a first rate of rise during a start-up phase of the fuel cell system (2) by means of the control unit,
after identifying the first rising phase (32, 38), monitoring (52) the measured temperature for a plateau (34, 40) of the measured temperature, during which a rate of rise of the measured temperature corresponds to at most a predetermined portion of a maximum first rate of rise,
identifying (54) a second rising phase (36, 42) following the plateau (34, 40), during which the measured temperature continuously rises at a second rate of rise which exceeds the rate of rise of the plateau (34, 40), and
during the plateau (34, 40), reducing (56) a conveyed volumetric flow rate of the coolant through the heat releasing device (18), and/or increasing (58) a current flow in the at least one fuel cell (4), and/or reducing (60) a cell voltage.

9. The method according to claim 8,
wherein the control unit (26) actuates a bypass valve (20) of a bypass (22) arranged parallel to the heat releasing device (18) during the plateau (34, 40) in order to guide coolant in the coolant path (14) at least partially through the bypass (22).

10. The method according to claim 8,
wherein the control unit (26) uses an initial rotational speed of the coolant pump (16), an ambient temperature of the fuel cell system (2), a heat input by the fuel cell system (2), and/or a presence or a chronological duration of the plateau (34, 40) to adapt control of the cooling device for subsequent starting under freezing conditions.
